(19) United States
(12) Patent Application Publication
(10) Pub. No.: US 2025/0054067 A1
(43) Pub. Date: Feb. 13, 2025

(54) CREATION AND MANAGEMENT OF ACCOUNTS FOR INSURED PERSONS

(71) Applicant: The PNC Financial Services Group, Inc., Pittsburgh, PA (US)

(72) Inventor: R. Keith Henry, Port Saint Lucie, FL (US)

(21) Appl. No.: 18/230,937

(22) Filed: Aug. 7, 2023

(51) Int. Cl. G06Q 40/08; G06Q 40/02

(52) U.S. Cl. CPC G06Q 40/08; G06Q 40/02

(57) ABSTRACT

A system for managing collecting deductibles of insureds is disclosed. The system comprises an automated computer vision system configured to identify and analyze information provided by a prospective enrollee on a form. The system further comprises a processor configured to establish a primary account associated with an insurance company to maintain a balance equivalent to a sum of fees incurred by insurance coverage plans sponsored by the insurance company, receive the information associated with the prospective enrollee from the automated computer vision system, and establish a sub-account associated with the prospective enrollee underneath the primary account. The processor is further configured to maintain a ledger of the sub-account to reflect fee(s) incurred by the prospective enrollee during a coverage period.

### BACKGROUND

Medicare is a U.S. government health insurance program that subsidizes healthcare services for anyone age 65 or older, younger people with disabilities, and patients with end-stage renal disease. Medicare is made up of several plans covering particular aspects of health care. As long as a person is eligible to receive Social Security benefits when he/she turns 65, the person is automatically enrolled in Medicare Part A, which covers hospital costs, and Medicare Part B, which covers a person's visits to the doctor.

As Medicare oftentimes does not fully cover all treatments and services, “gaps” remain that supplemental policies can fill. There are ten standardized Medicare Supplement policies (A, B, C, D, F, G, K, L, M, N) that help reduce a person's costs under Original Medicare (Part A and B). While enrollment into Medicare Parts A and B are automatic, a person must enroll themselves in any desired supplemental policy.

Medicare Supplement Plan G, also called Medigap Plan G, is one such supplemental policy that covers the “gaps” in Medicare except the Part B deductible. Stated another way, Plan G covers everything that Medicare Part A or B cover at 100% except for the Part B deductible. This means that a person will not pay anything out-of-pocket for covered services and treatments after the person pays the deductible, which was $233 in 2022, for example.

Participation in Medicare Supplement Plan G policy comes at a monthly cost to an enrollee. An average monthly cost for enrollment in such a supplemental plan ranges from $100 to $200 depending on factors including the enrollee's age and location, for example. Stated another way, the monthly cost of participation in Medicare Supplement Plan G is not uniform and varies amongst particular enrollees.

Given the multitude of plans selectable by individual insured persons and the intricate options associated therewith, managing collections and provider payments is difficult.

### SUMMARY

In one general aspect, the present invention is directed to computer-implemented systems and methods for managing collecting deductibles of insureds. In one embodiment, the system comprises an automated computer vision system that is configured to identify a type of form completed by a prospective enrollee based on an analysis of a received form and analyze, based on the type of form identified, information provided by the prospective enrollee on the returned form. The information comprises: an election of insurance coverage offered by a particular insurance company; an identifier of the prospective enrollee; and a payment method supplied to cover a cost associated with the election of insurance coverage. The automated computer vision system is also configured to verify the returned form comprises an authorization signature of the prospective enrollee.

The system also comprises a processor that is configured to establish a primary account associated with the particular insurance company, where the primary account maintains a balance equivalent to a sum of fees incurred by insurance coverage plans sponsored by the particular insurance company. The processor is also configured to receive the information associated with the prospective enrollee from the automated computer vision system; establish a sub-account associated with the prospective enrollee underneath the primary account, where the sub-account is established based on the information received from the automated computer vision system; and maintain a ledger of the sub-account to reflect a fee incurred by the prospective enrollee during a coverage period. The processor is configured to cause the payment method provided by the prospective enrollee to be charged for the fee incurred by the prospective enrollee; cause the fee incurred by the prospective enrollee to be deposited in the primary account; and disperse, to the particular insurance company, the balance of the primary account at a pre-determined interval, where the balance of the primary account reflects fees incurred under insurance coverage plans sponsored by the particular insurance company.

These and other advantages that can be realized through embodiments of the present invention will be apparent from the description that follows.

### FIGURE DESCRIPTIONS

Various embodiments of the present invention are described herein by way of example in connection with the following figures.

FIG. 1 depicts an insurance plan enrollment form according to at least one aspect of the present disclosure.

FIG. 2 is a flow chart representing an automated process for reviewing a completed insurance plan enrollment form of FIG. 1.

FIG. 3 is a schematic representing a hierarchy of accounts used to manage the dispersal of funds for insurance claims according to at least one aspect of the present disclosure.

FIG. 4 is a flow chart representing the actions of a financial institution in response to a received insurance claim payment request according to at least one aspect of the present disclosure.

FIG. 5 is a flow chart representing a process of generating account statements according to at least one aspect of the present disclosure.

FIG. 6 is a flow chart representing a process of reviewing the contents of primary accounts and associated sub-accounts according to at least one aspect of the present disclosure.

Corresponding reference characters indicate corresponding parts throughout the several views. The exemplifications set out herein illustrate various disclosed embodiments, is one form, and such exemplifications are not to be construed as limiting the scope thereof in any manner.

### DETAILED DESCRIPTION

A person can enroll, or re-enroll, in Medicare Supplement Plan G, or any other insurance plan, through a healthcare and/or insurance company, such as UnitedHealth Group, Inc., for example. The company sponsoring the particular insurance plan can issue a hardcopy, written form for a prospective enrollee to complete and return, in hard or soft/electronic form, via suitable means. In various instances, the form is returned by the prospective enrollee to a third party financial institution for the management of enrollee elections. The receiving company can retain the competed forms in a secure location, such as a lockbox, until the forms are able to be processed.

The form includes various fields intended to collect applicant information necessary to enroll a person in his/her desired insurance plan. Such applicant information includes personal identification information as well as information pertaining to transferring funds related to the insurance coverage, such as any uncovered deductible amounts and/or the insurance plan's monthly cost, electronically.

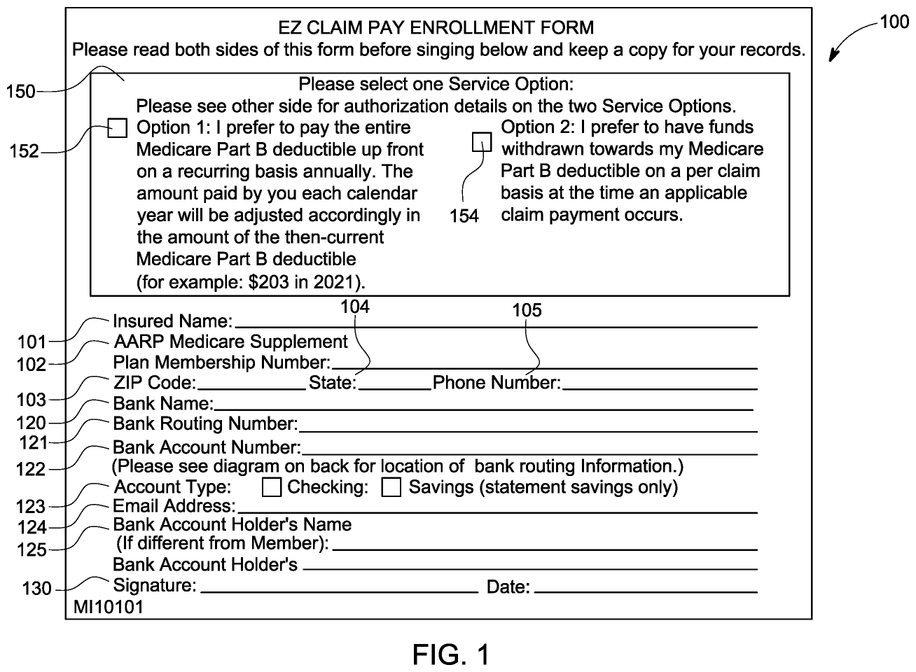

As shown in FIG. 1, a hardcopy form 100 for enrolling in Medicare Supplement Plan G includes a field for identifying the applicant by his/her name 101 and corresponding American Association of Retired Persons (AARP) Medicare Supplement Plan Membership Number 102. The form 100 requests the enrollee's zip code 103, state 104, and phone number 105 for contact and/or monthly rate-setting purposes, for example.

The form 100 further includes various fields requesting the applicant's banking information to facilitate the garnishment of monthly costs associated with enrollment in Medicare Supplement Plan G as well as any future accrued fees under the uncovered Part B deductible, for example. Such fields request the name of the bank where the applicant's account is held 120, the routing number 121 associated with the applicant's account, the account number 122 associated with the applicant's account, and an identification of the account type 123. For authentication and/or communication purposes, the form 100 provides fields for collecting the email address 124 associated with the listed bank account and the account holder's name 125, if different than the applicant's name 101. Authorization for use of such financial account information is required on the form 100 by way of the fields corresponding to an account holder's signature and form completion date 130. While the depicted form 100 includes all of the described fields, it is envisioned that any suitable combination of fields are present on the form that appropriately identifies an applicant and a payment method while also providing authorization for garnishment of necessary funds.

As described herein, Medicare Supplement Plan G does not cover the deductible associated with Part B of Medicare. As such, the enrollee is responsible for paying all incurred costs under Part B of Medicare until an amount equal to the Part B deductible has been paid. The company sponsoring the Medicare Supplement Plan G can provide an enrollee with an option of how and/or when to pay the Part B deductible. In one instance, the enrollee can elect to pay the entire Part B deductible at the beginning of a coverage period, or term, such as a year. In such instances, beyond the monthly plan fee of Medicare Supplement Plan G, the enrollee is not responsible for any out-of-pocket costs associated with any received healthcare services and/or treatments. In an alternate instance, the enrollee can elect to pay out-of-pocket as fees are incurred under Part B of Medicare during the coverage period until the Part B deductible has been reached. Such a payment structure does not require the enrollee to pay upfront for the Part B deductible, which may not be used during the particular coverage period. The form 100 shown in FIG. 1 further provides a field 150 for the enrollee to elect between two service options including (i) paying the Part B deductible upfront 152 and (ii) paying for the Part B deductible out-of-pocket 154 as costs are incurred.

Upon completing the form 100 with his/her information, the enrollee returns the form to a company, such as the insurance company or a financial institution, for processing. In instances where the insurance company is the receiving company, the insurance company may forward the form to a financial institution for processing and/or management. In other instances, the insurance company may process the form on its own. The enrollee can return the form by way of physical mail or postal service, by scanning the form into a computer and emailing and/or uploading the electronic version of the form generated from the scan, or by any other suitable communication method. The receiving company is configured to process the returned form to extract the provided information and/or to determine if the form was properly and/or sufficiently completed, for example.

In various instances, the form 100 is provided to both prospective enrollees and previous enrollees whose coverage periods have expired. Stated another way, an enrollee who completed the form at the beginning of a first coverage period is provided with a subsequent form to complete prior to the start of a second, subsequent coverage period. Should the enrollee not complete the subsequent form, the enrollee will no longer be enrolled in the particular insurance coverage plan.

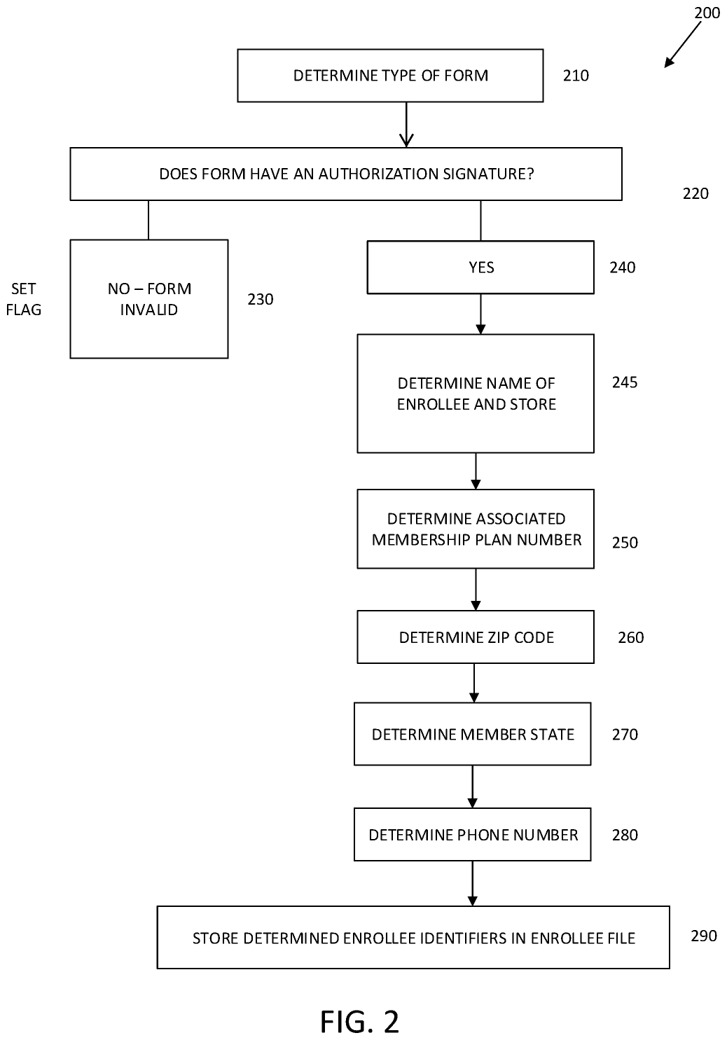

An exemplary process 200 for automated handling of the forms by analyzing and/or compiling the information presented thereon is outlined in the flow chart of FIG. 2. While the depicted process is intended to be performed with a computer processor, manual, operator intervention is envisioned as necessary to facilitate and/or advance the process. At least one of the insurance company and the financial institution have an automated computer vision system capable of reading the prospective enrollee-returned forms.

Particularly for returned hardcopy forms, the computer vision comprises an imager (e.g., a camera or scanner, or set of cameras/scanners) for capturing a digital image of the form. From the digital image, a processor, such as a processor of a computer vision system, is configured to determine the type of form 210 received by the receiving company, or financial institution. The camera/scanner can have a resolution of at least 300 dots/inch, for example, with a camera resolution of 5 mega pixels or greater, for example. Such determination can be made by comparing the image of the received form to images of various form types stored in a memory of such computer vision system. Recognizing that the received form is associated with enrollment in a particular insurance plan, such as Medicare Supplement Plan G, the computer vision system is configured to determine whether the received form contains an acceptable authorization signature 220 in the appropriate field on the received form. The processor can make this determination by examining the area for the signature to determine if it includes features indicative of a signature.

If the processor is unable to detect an authorization signature or an authorization signature is not acceptable 230, the processor is configured to set a flag as an alert that the received form is insufficient and/or requires additional information from the prospective enrollee. In instances where the processor detects the presence of an acceptable authorization signature 240, the processor is configured to determine the name of the prospective enrollee 245. This function may be performed by optical character recognition (OCR) of the signature. The authenticity of the signature does not necessarily need to be verified. The processor is configured to store, in an entry or record in an associated database, the determined name of the prospective enrollee in a created file specific to the prospective enrollee. The processor is configured to gather additional identifying information of the prospective enrollee including a zip code 260, residential state 270, and phone number 280, for example. Again, this information can be collected by OCR of the areas of the form where the information is supposed to be. In that sense, the computer vision system can exploit the standard-nature of the form. It can presume that the information appearing in the zip code field 260 is a zip code, that the information appearing in the residential states field 270 is a state, and so on. Some of these fields have finite possibilities (like zip codes, states, etc.), so the processor can compare the recognized characters for the zip code, state, etc. to the finite list of possibilities to determine if what the processor read (via OCR) is possibly valid (e.g., one of the finite possibilities). The processor compiles all of the detected enrollee-identifiers in the created enrollee-specific record 290 for electronic communication to the financial institution and/or insurance company.

In various instances, the information provided on the form 100 and detected by the processor is configured to be stored in a Nacha-compliant database. For example, the data captured from the forms can be encrypted; commercially reasonable encryption technology can be utilized for all transmission of data to and/or from the system via an unsecured network (e.g. the Internet). In various aspects, the captured data is stored in the compliant database in an electronic format in which the data is unreadable at rest. The data can be encrypted with at least 128-bit encryption protocols and, in other instances, at least 256-bit encryption. For example, 128-bit or 256-bit advanced encryption system (AES), SSL or RSA encryption could be employed for the database(s) storing the customer data captured from the forms. Implementations of the processes disclosed herein provide improvements by way of decentralized computing, data incorruptibility, transparency and redundancy, or secure authentication.

While the prospective enrollee's information is described as being collected through the completion of a physical form, it is envisioned that such information can also be provided in other manners. For example, a prospective enrollee can enroll in a particular insurance plan using the prospective enrollee's phone number by way of a customer service record (CSR). A CSR is a document detailing all the legal ownership attributes of a phone number including items such as authorized signer and service address. In such instances, when the prospective enrollee is ready to enroll in a particular insurance plan, the prospective enrollee calls the customer service department associated with the insurance and/or healthcare company. The insurance and/or healthcare company will capture required information to create an account to support automatic debit payments for the prospective enrollee. Similar to the information collected on the physical form, the prospective enrollee must elect between paying the uncovered deductible upfront or only pay out-of-pocket for incurred costs. The insurance and/or healthcare company records such an election and communicates such information to the third party financial institution for implementation.

Creation and Funding of Accounts. An insurance and/or healthcare company that desires to sponsor an insurance plan provides a financial institution with a dedicated account to which electronic funds associated with insurance claims can be transferred. Prospective enrollees, the insurance and/or healthcare company, and/or a verified third party communicates the prospective enrollee's information collected via the physical form, a phone call, or any other suitable means, to a financial institution to establish enrollee-specific accounts for electronic management of funds for dispersal and collection. Such information can be communicated to the financial institution by the insurance and/or healthcare company by way of a Secure File Transfer Protocol (SFTP). Prior to creating user accounts associated with each prospective, or otherwise insured, party the financial institution passes such received information through Anti-Money Laundering (AML) and Know Your Customer (KYC) processes in an effort to prevent financial crimes and verify each particular enrollee's identity, respectively. Should a process, such as AML, fail, further enrollee validation is necessary, and the system of the financial institution will request such validating information from the insurance company.

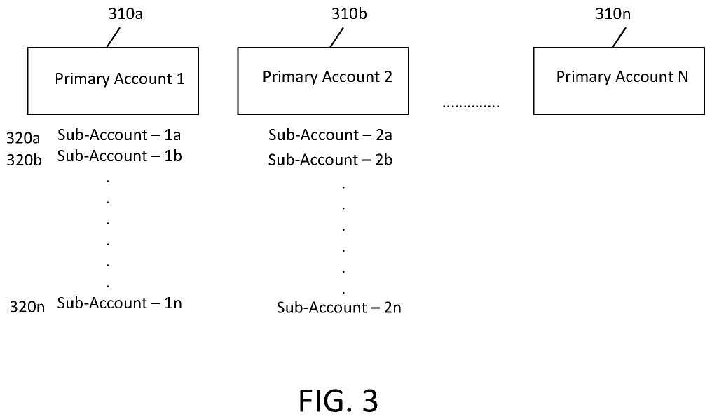

As shown in FIG. 3, a primary bank account 310a, 310b, 310n is established in the form of a controlled disbursement account for each healthcare and/or insurance company with funds managed by the financial institution. Taking the primary bank account associated with a first insurance company 310a as an example, individual sub-accounts 320a, 320b . . . 320n are created thereunder specific to each insured enrollee upon clearing the AML and KYC processes. A first sub-account 320a is associated with a first enrollee and maintains a ledger of all transactions relevant to the first enrollee's elected insurance plan. The first sub-account 320a also includes first enrollee-specific information such as, the name of the first enrollee, and/or the Member ID of the first enrollee, and/or an Item ID (i.e., applicable coverage period—2022). A second sub-account 320b is associated with a second enrollee and likewise maintains a ledger of all transactions relevant to the second enrollee's elected insurance plan. The first sub-account 320a also includes second enrollee-specific information such as, the name of the second enrollee, and/or the Member ID of the second enrollee, and/or an Item ID (i.e., applicable coverage period—2022).

While the primary bank accounts associated with the healthcare and/or insurance companies are intended to be actual bank accounts, the sub-accounts created underneath are not bank accounts and exist as shadow accounts to track funds allocated to the associated insurance enrollee. Stated another way, the primary bank account associated with each particular insurance company holds the sum of funds from the ledgers of the individual sub-accounts created thereunder. A valuable distinction between the primary bank accounts and the sub-accounts is that the sub-accounts do not require a monthly carrying fee as is required by most actual bank accounts.

Claim Payments. As insurance claims of an insurance company's insured members arise, communication between the insurance company and the financial institution facilitate the payment of fees associated with such claims. More specifically, the insurance company and/or healthcare provider communicates with the financial institution to request payment for an insurance claim associated with a particular insured member. Upon analyzing the ledger balance of the particular insured member, the financial institution initiates a transfer, or payment, of funds from the primary bank account to the provider while also shadowing this transaction in the associated sub-account balance as detailed below.

Maintaining individual sub-accounts for each enrollee affords various benefits, such as providing clarity and organization to the fund management process while also streamlining dispersal and/or collection of funds, for example. The management of such funds quickly becomes complicated as not all enrollees elect to pay the Part B deductible upfront. Stated another way, some enrollees elect to pay for any uncovered Part B expenses as they arise while other enrollees elect to pay the entire Part B deductible upfront for a particular coverage period. Even in instances where enrollees elect to pay the Part B deductible upfront, not all enrollees require the use of such funds at all and/or at the same time and/or amount during the coverage period.

Referring back to the example involving the primary bank account associated with the first insurance company 310a, at the beginning of a coverage period the first sub-account 320a “holds” the Part B deductible as the first enrollee elected to pay the Part B deductible upfront. As the first sub-account 320a is not intended to literally hold money, the first sub-account 320a “holds” or tracks the value of the Part B deductible in the form of a ledger. As insurance claims are processed under the first enrollee's insurance plan, any balance not covered by the first enrollee's Part B Medicare plan is deducted from the ledger balance of the first sub-account 320a. The balance of the first sub-account 320a continues to be deducted from until the balance has been exhausted and/or the coverage period comes to an end.

As discussed above, the second sub-account 320b is also created underneath the first primary bank account 310a and reflects a ledger balance specific to a second enrollee in the first insurance and/or healthcare account's insurance plan. Different from the first enrollee, the second enrollee elected to only pay a cost associated with an insurance claim under Medicare Part B if and/or when such a claim arises. As such, the balance at the beginning of the coverage period in the second sub-account 320b is zero. As insurance claims arise under Medicare Part B, the financial institution initiates a charge to the bank account provided on the second enrollee's plan enrollment form. The second enrollee's provided bank account then transfers the outstanding balance to the primary bank account associated with the first insurance company 310a, and a record of such transaction is reflected in the second sub-account 320b ledger.

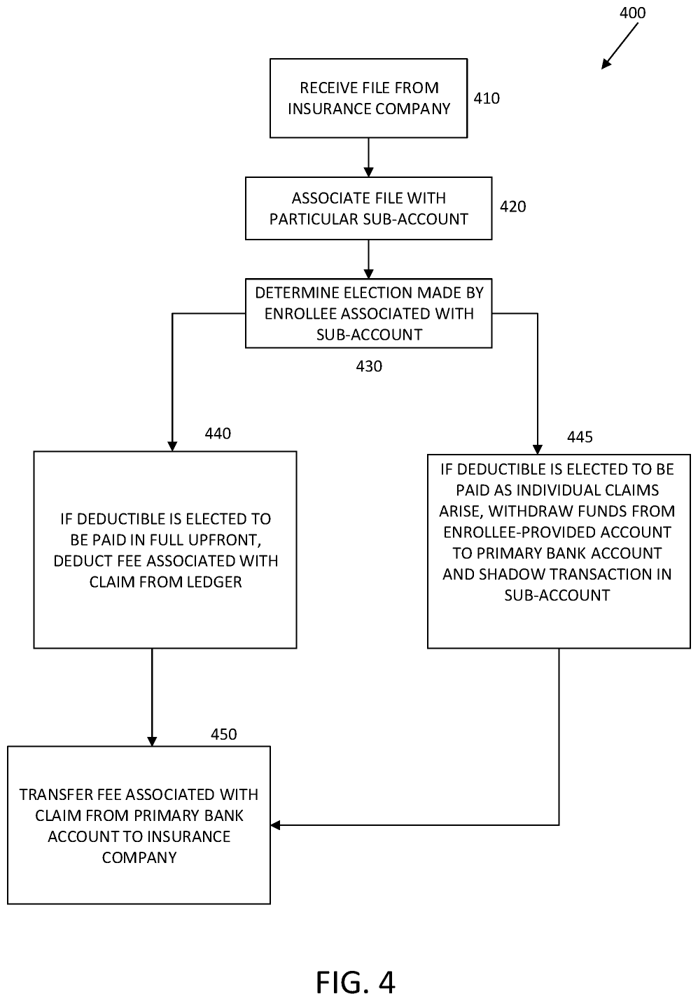

An example request and payment process 400 is depicted in FIG. 4. The financial instrument is configured to receive a file 410 electronically from a particular insurance and/or healthcare provider. Such a file can be sent by way of a Secure File Transfer Protocol (SFTP) or any other suitable, secure communication method, over an electronic data network, such as the Internet, a LAN, a WAN, etc. The electronic file includes information pertaining to a specific enrollee including the enrollee's Member ID and date and description of the particular service and/or procedure that resulted in the generated claim. Such file further includes the outstanding fee associated with the claim. The financial institution is configured to associate the received file 420 with a specific sub-account based on the information received in the file.

Once the particular sub-account to which the claim pertains has been identified, the financial institution must recognize the payment election 430 made by the enrollee associated with the sub-account. In instances where the enrollee elected to pay the deductible associated with the insurance plan upfront, the financial institution is configured to deduct the fee associated with the claim from the ledger balance of the sub-account 440. Assuming the ledger balance of the sub-account is sufficient to cover the fee requested by the insurance company, the financial institution is configured to transfer the fee associated with the claim from a primary bank account to the insurance company 450. Instances where the requested fee is greater than the ledger balance might indicate that the enrollee has met his/her deductible and is not required to pay the entirety of the requested fee. The financial institution is configured to communicate any such inconsistencies with the insurance company for review.

In alternate instances where the enrollee elected to pay as claims arise, the financial institution is configured to withdraw funds from the enrollee-provided bank account associated with the identified sub-account 445. Such withdrawn funds can be sent to the primary bank account at the financial institution and subsequently transferred to the insurance company 450. Once again, if the ledger of the sub-account indicates that a threshold deductible amount has already been paid to the insurance company, the financial institution is configured to communicate such inconsistency to the insurance company for review. Stated another way, even in instances where the enrollee pays out-of-pocket as claims arise, the financial institution places a limit (equal to the particular deductible) on the sub-accounts to prevent overpayment to the insurance company.

The financial institution can transfer funds from the primary account to the insurance company in any suitable manner. For example, such funds can be transferred electronically through a wire payment or by mailing a physical check. In any event, the fund transfer is accompanied by a description including identifiers such as the sub-account number from which the funds were deducted from, the insurance claim number and associated description, and/or any suitable information to link the payment the correct enrollee and/or claim.

Reporting. At any point throughout the coverage period, such as daily or weekly, for example, the financial institution can generate an activity report reflecting specific activities involving transfers of funds into and/or out of the primary account. Such an activity report can include information pertaining to the individual sub-accounts involved and/or any particular insurance claim numbers and descriptions. The activity report can be communicated to the relevant insurance company, an internal service, and/or a third party service to initiate enrollee communications.

In various instances, the presence of a particular enrollee's sub-account on an activity report can trigger a system of the financial institution to generate statements associated with the enrollee's sub-account and communicate such generated statements to the particular enrollee. Such communication can be sent by email, mail, and/or other suitable communication forms. In various instances, such statements can mimic a template provided by the insurance company to provide a cohesive experience for an enrollee, for example.

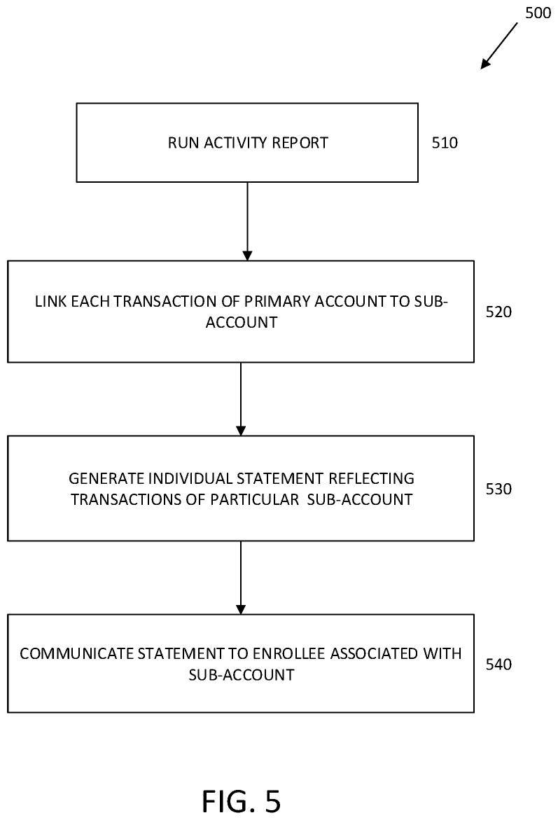

An example process for analyzing generated activity reports 500 is depicted in FIG. 5. At the outset, the financial institution is configured to run an activity report 510 that is reflective of any transactional activity within the primary account. The financial institution is configured to link each transactional activity within the primary account to a specific sub-account 520. The presence of a specific sub-account on the activity report triggers the financial institution to generate an individual statement 530 reflecting the transactions that occurred within the primary account relevant to the specific sub-account. The financial institution is configured to communicate such individualized statement 540 to the enrollee associated with the sub-account.

At the conclusion of a particular coverage period, or annually, an extended activity report is generated for each primary account and/or each sub-account. In such instances, a communication in the form of an individualized statement is sent to all enrollees, regardless of whether transactional activity has occurred within his/her sub-account during the coverage period.

Unused Deductibles. At the conclusion of a particular coverage period, an audit, or other suitable review form, of the sub-accounts under each primary bank account is performed to assess which sub-accounts contain a non-zero balance. Such sub-accounts with a positive balance represent situations involving enrollees who paid upfront for the Part B deductible and did not exhaust the funds or enrollees who overpaid and/or mistakenly paid for an out-of-pocket Part B deductible claim. Sub-accounts may hold negative balances in instances where the associated enrollee elected to pay for claims under the Part B deductible out-of-pocket as such claims arise and did not yet pay the billed cost.

In various instances, such audits can occur more or less frequently than at the conclusion of a particular coverage period. For example, in accounts with a high amount of transactional activity, a monthly audit may be desirable. In other instances, for accounts having a standard amount of transaction activity, a yearly audit may be sufficient and/or manageable. In any event, the frequency of such audits can be tailored to the requests of individual insurance and/or healthcare companies and their enrollees.

In instances where a positive balance remains in a particular sub-account, the financial institution is configured to hold such funds for a reasonable period, such as 90 days, to allow for any unprocessed provider claims to be received and settled. The funds that remain after expiration of the reasonable period are returned to the enrollee by any suitable method, including by mail or electronic transfer, for example. An explanation of the transferred funds is attached to all correspondence. The balances of both the primary accounts and their respective sub-accounts are intended to be zero prior to beginning a new coverage period. In various instances, primary accounts and their associated sub-accounts can be deleted upon the completion of each coverage period. In such instances, should an insurance and/or healthcare company and its enrollees elect to engage the services of the financial institution for a subsequent coverage period, new accounts will be created.

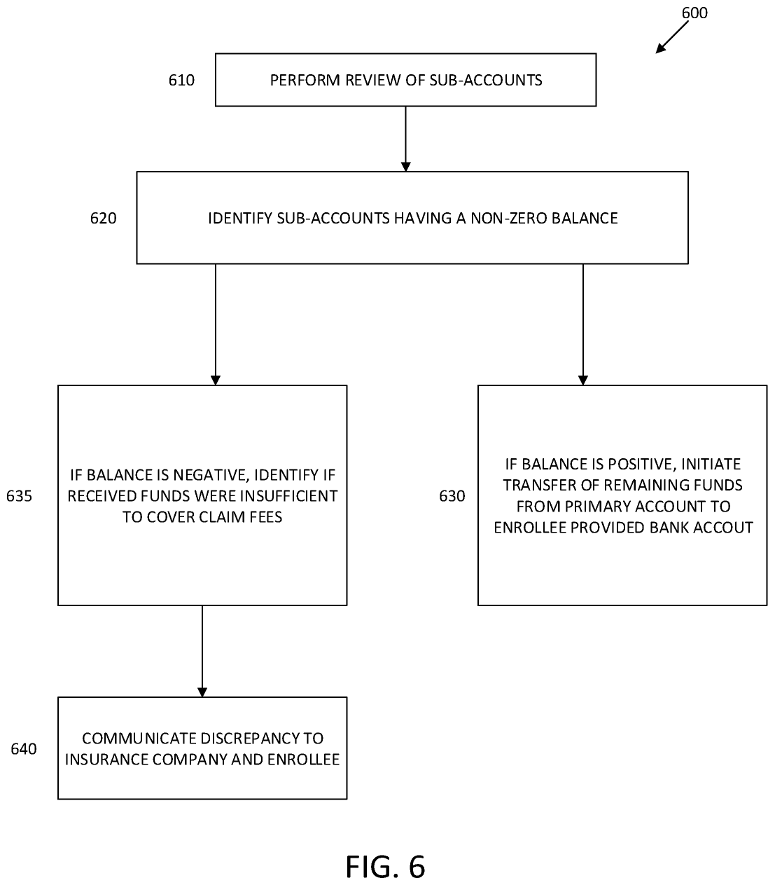

An example process for reviewing sub-accounts 600 is depicted in FIG. 6. The financial institution is configured to perform a review of all sub-accounts 610 on a regularly-scheduled duration and/or at the request of an insurance company and its enrollees. During its review, the financial institution is configured to identify sub-accounts that have a non-zero balance 620. If the identified non-zero balance is positive, the financial institution is configured to initiate a transfer of the remaining funds back to the enrollee-provided bank account 630. Because the sub-accounts themselves do not “hold” actual funds, the financial institution initiates the transfer of funds from the primary account to the enrollee-provided bank account. Such an initiation of funds transfer can also include communicating, via a statement, an explanation of payment to the applicable parties. If the identified non-zero balance is negative, the financial institution is configured to identify if funds garnished from the enrollee were insufficient to cover claim fees requested by the insurance company 635. The financial institution is configured to communicate any such inconsistencies to both the insurance company and the enrollee associated with the particular sub-account 640.

A financial institution can selectively implement the disclosed processes or combinations thereof as it sees fit and/or in response to requests by the insurance and/or healthcare companies and their enrollees. The disclosed processes are intended to be repeated and/or rearranged in response to any request from insurance and/or healthcare companies and their enrollees.

In one general aspect, therefore, the present invention is directed to a system for managing collecting deductibles of insureds. The system has an automated computer vision system configured to identify a type of form completed by a prospective enrollee based on an analysis of a received form and analyze, based on the type of form identified, information provided by the prospective enrollee on the returned form. The information includes an election of insurance coverage offered by a particular insurance company, an identifier of the prospective enrollee, and a payment method supplied to cover a cost associated with the election insurance coverage. The automated computer vision system is further configured to verify the returned form has an authorization signature of the prospective enrollee. The system further has a processor configured to establish a primary account associated with the particular insurance company, wherein the primary account maintains a balance equivalent to a sum of fees incurred by insurance coverage plans sponsored by the particular insurance company, receive the information associated with the prospective enrollee from the automated computer vision system, and establish a sub-account associated with the prospective enrollee underneath the primary account, wherein the sub-account is established based on the information received from the automated computer vision system. The processor is further configured to maintain a ledger of the sub-account to reflect a fee incurred by the prospective enrollee during a coverage period, cause the payment method provided by the prospective enrollee to be charged for the fee incurred by the prospective enrollee, cause the fee incurred by the prospective enrollee to be deposited in the primary account, and disperse, to the particular insurance company, the balance of the primary account reflects fees incurred under insurance coverage plans sponsored by the particular insurance company.

The election of insurance coverage indicates a time desired by the prospective enrollee for the system to garnish a deductible during the coverage period.

The ledger of the sub-account reflects a transaction history of any fee incurred by the prospective enrollee during the coverage period.

The ledger of the sub-account comprises a threshold value. The processor prevents the payment method provided by the prospective enrollee from being charged in instances where the threshold value has been reached.

The ledger balance of the sub-account is zero prior to a start of the coverage period.

The ledger balance of the sub-account is zero upon completion of the coverage period.

The processor is configured to cause a reimbursement to be issued to the payment method provided by the prospective enrollee in an event that the ledger balance of the sub-account reflects a non-zero balance at an end of the coverage period.

The processor is configured to store the payment method provided by the prospective enrollee in an encrypted database.

The primary account is a bank account.

The sub-account is not a bank account.

The processor is configured to cause a statement to be communicated to the prospective enrollee reflective of an activity summary associated with the sub-account.

The processor is configured to store the information provided by the prospective enrollee in an encrypted manner.

In another general aspect, the present invention is directed to a system for managing collecting deductibles of insureds. The system has a processor configured to establish a primary account associated with a particular insurance company, wherein the primary account maintains a balance equivalent to a sum of fees incurred by insurance coverage plans sponsored by the particular insurance company. The processor is further configured to receive information associated with a prospective enrollee, wherein the information includes an election of insurance coverage offered by the particular insurance company, an identifier of the prospective enrollee, and a payment method supplied to cover a cost associated with the election of insurance coverage. The processor is further configured to establish a sub-account associated with the prospective enrollee underneath the primary account, wherein the sub-account is established based on the information received and maintain a ledger of the sub-account to reflect a fee incurred by the prospective enrollee during a coverage period. The processor is further configured to cause a payment method associated with the prospective enrollee to be charged for the fee incurred by the prospective enrollee, cause the fee incurred by the prospective enrollee to be deposited in the primary account, and disperse, to the particular insurance company, the balance of the primary account at a pre-determined interval, wherein the balance of the primary account reflects fees incurred under insurance coverage plans sponsored by the particular insurance company.

The system further has an automated computer vision system configured to identify a type of form completed by the prospective enrollee based on an analysis of a received form, analyze, based on the type of form identified, information provided by the prospective enrollee on the returned form, verify the returned form has an authorization signature of the prospective enrollee, and communicate the information to the processor.

In another general aspect, the present invention is directed to a method for managing collecting deductibles of insureds. The method includes establishing a primary account associated with a particular insurance company, maintaining a balance in the primary account equivalent to a sum of fees incurred by insurance coverage plans sponsored by the particular insurance company, and receiving information associated with a prospective enrollee. The information includes an election of insurance coverage offered by the particular insurance company, an identifier of the prospective enrollee, and a payment method supplied to cover a cost associated with the election of insurance coverage. The method further includes establishing, based on the information received, a sub-account associated with the prospective enrollee underneath the primary account and maintaining a ledger of the sub-account to reflect a fee incurred by the prospective enrollee during a coverage period. The method further includes causing a payment method associated with the prospective enrollee to be charged for the fee incurred by the prospective enrollee, causing the fee incurred by the prospective enrollee to be deposited in the primary account, and dispersing, to the particular insurance company, the balance of the primary account at a pre-determined interval. The balance of the primary account reflects fees incurred under insurance coverage plans sponsored by the particular insurance company.

Though various methods and computer systems discloser herein refer to a healthcare services payer, however, these methods and computer systems are applicable to other payers, as well. The compliant collections systems disclosed herein can be utilized by various service providers in different circumstances for the compliant collection of premiums by a financial institution at regular intervals.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A system for managing collecting deductibles of insureds, the system comprising:
an automated computer vision system configured to:
identify a type of form completed by a prospective enrollee based on an analysis of a received form;
analyze, based on the type of form identified, information provided by the prospective enrollee on the returned form, wherein the information comprises:
an election of insurance coverage offered by a particular insurance company;
an identifier of the prospective enrollee; and
a payment method supplied to cover a cost associated with the election of insurance coverage; and
verify the returned form comprises an authorization signature of the prospective enrollee; and
a processor configured to:
establish a primary account associated with the particular insurance company, wherein the primary account maintains a balance equivalent to a sum of fees incurred by insurance coverage plans sponsored by the particular insurance company;
receive the information associated with the prospective enrollee from the automated computer vision system;
establish a sub-account associated with the prospective enrollee underneath the primary account, wherein the sub-account is established based on the information received from the automated computer vision system;
maintain a ledger of the sub-account to reflect a fee incurred by the prospective enrollee during a coverage period;
cause the payment method provided by the prospective enrollee to be charged for the fee incurred by the prospective enrollee;
cause the fee incurred by the prospective enrollee to be deposited in the primary account; and
disperse, to the particular insurance company, the balance of the primary account at a pre-determined interval, wherein the balance of the primary account reflects fees incurred under insurance coverage plans sponsored by the particular insurance company.

2. The system of claim 1, wherein the election indicates a time desired by the prospective enrollee for the system to garnish a deductible during the coverage period.

3. The system of claim 1, wherein the ledger of the sub-account reflects a transaction history of any fee incurred by the prospective enrollee during the coverage period.

4. The system of claim 1, wherein the ledger of the sub-account comprises a threshold value, and wherein the processor prevents the payment method provided by the prospective enrollee from being charged in instances where the threshold value has been reached.

5. The system of claim 1, wherein the ledger balance of the sub-account is zero prior to a start of the coverage period.

6. The system of claim 5, wherein the ledger balance of the sub-account is zero upon completion of the coverage period.

7. The system of claim 6, wherein the processor is further configured to cause a reimbursement to be issued to the payment method provided by the prospective enrollee in an event that the ledger balance of the sub-account reflects a non-zero balance at an end of the coverage period.

8. The system of claim 1, wherein the processor is further configured to store the payment method provided by the prospective enrollee in an encrypted database.

9. The system of claim 1, wherein the primary account is a bank account.

10. The system of claim 9, wherein the sub-account is not a bank account.

11. The system of claim 1, wherein the processor is further configured to cause a statement to be communicated to the prospective enrollee reflective of an activity summary associated with the sub-account.

12. The system of claim 1, wherein the processor is further configured to store the information provided by the prospective enrollee in an encrypted manner.

13. A system for managing collecting deductibles of insureds, the system comprising:
a processor configured to:
establish a primary account associated with a particular insurance company, wherein the primary account maintains a balance equivalent to a sum of fees incurred by insurance coverage plans sponsored by the particular insurance company;
receive information associated with a prospective enrollee, wherein the information comprises:
an election of insurance coverage offered by the particular insurance company;
an identifier of the prospective enrollee; and
a payment method supplied to cover a cost associated with the election of insurance coverage;
establish a sub-account associated with the prospective enrollee underneath the primary account, wherein the sub-account is established based on the information received;
maintain a ledger of the sub-account to reflect a fee incurred by the prospective enrollee during a coverage period;
cause a payment method associated with the prospective enrollee to be charged for the fee incurred by the prospective enrollee;
cause the fee incurred by the prospective enrollee to be deposited in the primary account; and
disperse, to the particular insurance company, the balance of the primary account at a pre-determined interval, wherein the balance of the primary account reflects fees incurred under insurance coverage plans sponsored by the particular insurance company.

14. The system of claim 13, further comprising an automated computer vision system configured to:
identify a type of form completed by the prospective enrollee based on an analysis of a received form;
analyze, based on the type of form identified, information provided by the prospective enrollee on the returned form;
verify the returned form comprises an authorization signature of the prospective enrollee; and
communicate the information to the processor.

15. A method for managing collecting deductibles of insureds, the method comprising:
establishing a primary account associated with a particular insurance company;
maintaining a balance in the primary account equivalent to a sum of fees incurred by insurance coverage plans sponsored by the particular insurance company;
receiving information associated with a prospective enrollee, wherein the information comprises:
an election of insurance coverage offered by the particular insurance company;
an identifier of the prospective enrollee; and
a payment method supplied to cover a cost associated with the election of insurance coverage;
establishing, based on the information received, a sub-account associated with the prospective enrollee underneath the primary account;
maintaining a ledger of the sub-account to reflect a fee incurred by the prospective enrollee during a coverage period;
causing a payment method associated with the prospective enrollee to be charged for the fee incurred by the prospective enrollee;
causing the fee incurred by the prospective enrollee to be deposited in the primary account; and
dispersing, to the particular insurance company, the balance of the primary account at a pre-determined interval, wherein the balance of the primary account reflects fees incurred under insurance coverage plans sponsored by the particular insurance company.
